(19) United States
(12) Patent Application Publication
(10) Pub. No.: US 2005/0102209 A1
(43) Pub. Date: May 12, 2005

(54) Method and system for computing personal and business financial information

(76) Inventors: Jon Sagrillo, Pewaukee, WI (US); Van Do, Centreville, VA (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/706,026

(22) Filed: Nov. 12, 2003

(51) Int. Cl. G06F 17/60

(52) U.S. Cl. 705/35

(57) ABSTRACT

A method and system for calculating a financial forecast or goal and/or budget based upon user-provided information. The user provided information may include past commission, success ratio, income and expenses as well as a projected financial goal. The forecast and budget is a factor of the past personal and business financial information and the projected production goal. Preferably, the forecast will include suggested success ratios, income and expenses to reach the projected production goal, which may include a commission goal.

### BACKGROUND OF THE INVENTION

The present invention relates to a method and system for generating financial information and in particular for computing personal and business financial information including but not limited to success ratios and production goals, which may comprise future income, expenses and commission information as a function of a user's past success ratios and production goals, which may comprise income, expenses and commission information.

Most independent sales agents are goal oriented. That is, most sales plans followed by sales agents and the like include goal setting as a means for achieving successful results in a given fiscal period. These periods may range from months to quarters of a year to years. Sales agents, e.g., real estate agents, use goal setting as a driving factor for planning, deciding and directing their day to day, month to month or year to year personal and business operations in order to stay on course and ensure forward progress in the pursuit of increased income and commissions as well as decreased expenses. In other words, goal setting assists agents in achieving certain personal and business financial goals. Optimum planning and decision-making to achieve these goals are based, in part, on maximizing the use of known information to predict future results.

Known methods for calculating financial data, such as projected budgets, may typically use past financial data to forecast and set future financial goals. For example, in known sales planning models, an agent may provide financial figures for the past year or so. After coordinating this data together with other similar historical data, a financial forecast may be generated and include expected income, expense and commission figures for the following year. Then, based upon this analysis, a sales plan of some sort will be set for the upcoming period.

In certain cases, for example, even though financial information from the past year(s), which is used to forecast financial information and create a sales plan for the upcoming year(s), may be accurate, it may not be the best indicator of future financial goals. This may be caused by a number of factors, including the fact that a commission goal may be set but the income and expenses needed to reach that commission goal may not be accurately calculated or even included. As such, the agent may fall short of his or her goals as a result of unexpected changes in income and/or expenses.

It would be desirable for an agent to include both personal and business financial data in a financial forecast calculation. In this regard, the inventors discovered a system and method for computing financial forecasts for businesses, such as brokerages. Aspects of that invention are described in copending, commonly assigned U.S. patent application Ser. No. 10/379,622 entitled METHOD AND SYSTEM FOR COMPUTING FINANCIAL FORECASTS, filed Mar. 5, 2003, the entirety of which is incorporated by reference herein. No admission is made that the '622 patent application is prior art. In the '622 patent application, the inventors do not address or account for personal financial information such as personal expenses, income, commission and the like or production goals and success ratios and the like. Thus, heretofore, no known method or system includes both personal and business financial information to be used to determine financial goals in the inventive combination and steps described hereinbelow.

### SUMMARY OF THE INVENTION

In accordance with one aspect of the present invention, there is provided a personal and business financial forecast for a predetermined forecast period. This aspect comprises receiving past personal and business financial data from a period preceding the predetermined forecast period; receiving personal and business financial goal data for the predetermined forecast period; and calculating a personal and business financial forecast for the predetermined forecast period as a function of the past personal and business financial data and the personal and business financial goal data.

In a preferred embodiment, at least a portion of the past personal and business financial data is generated from calculated results of production goal data. More preferably, the production goal data may comprise user-provided data taken from a group comprising commission per side, gross office commission, gross income goal, percentage of sides listing sold, percentage of sides buyers sold, percentage of open sides that closed, listing sold/listing taken percentage, closed sides goal, total open sides goal, list to sell goal, and list to take goal. The production goal may also include success ratios.

In another preferred embodiment, at least a portion of the past personal and business financial data may be generated from a pre-calculated average. Preferably, the pre-calculated average comprises an average of user-provided data from a plurality of users, taken from a group consisting of similar information as in the individual user case described above.

More preferably, the past personal and business financial data comprises commission, income and expense data from a past period preceding the predetermined personal and business financial forecast period. The forecast data preferably comprises forecasted income and expense data necessary to achieve a commission goal. It may also include past success ratio data.

Preferred embodiments of the present invention may include reporting the personal and business financial forecast to the user for review and, adjusting the personal and business financial goal data. Preferably, adjusting of the personal and business financial goal data is a function of adjusting data taken from a group comprising: personal and business expenses, income, commissions, units closed, listing seasonality, and selling seasonality. It may also include adjusting success ratios. Preferably, once the adjusted personal and business financial goal data and the adjusted forecast goal data have been accepted by the user, a personal and business financial budget may be calculated for the predetermined personal and business financial forecast period as a function of the accepted personal and business financial goal data and the accepted either one of income or expense data.

The period preceding the predetermined financial forecast period may be at least one or more months or years.

In a most preferred embodiment, the method further comprises generating a monthly worksheet for the predetermined personal and business financial forecast period as a function of the accepted personal and business financial goal data and the accepted either one of income and expense data. The worksheet may include charts and graphs.

In yet another embodiment of this aspect of the present invention, the method comprises computer-assisted steps and is at least partly performed over a network between the user and an automated forecast provider. Most preferably, the network includes at least part of the Internet.

In another aspect of the present invention, there is provided a computer system for providing to a user a financial forecast for a predetermined forecast period, the computer system including at least one processing unit operable to execute one or more executable programs. The one or more executable programs cause the at least one processing unit to perform steps comprising receiving past personal and business financial data from a period preceding the predetermined personal and business financial forecast period, receiving personal and business financial goal data for the predetermined personal and business financial forecast period, and computing a personal and business financial forecast for the predetermined financial forecast period as a function of the past personal and business financial data and the personal and business financial goal data.

In a preferred embodiment, at least some of the steps of the computer system are performed over a network between the user and the at least one processing unit. Most preferably, the network includes at least part of the Internet.

In yet another aspect of the present invention, there is provided a method for providing to a user, over a computer network, a personal and business financial forecast for a predetermined personal and business financial forecast period. This aspect comprises providing a website system that includes a graphics user interface having a plurality of data entry fields capable of being populated and/or viewed by the user or automatically, receiving in at least one of the plurality of data entry fields past personal and business financial data from a period preceding the predetermined financial forecast period, receiving in at least another one of the data entry fields personal and business financial goal data for the predetermined financial forecast period, calculating a personal and business financial forecast for the predetermined financial forecast period as a function of the past personal and business financial data and the personal and business financial goal data, and transmitting the personal and business financial forecast to the user via the computer network.

In yet another aspect of the present invention, there is provided a computer-implemented method of providing to a user a personal and business financial forecast for a predetermined financial forecast period. In a preferred embodiment, the computer-implemented method comprises receiving past personal and business financial data from a period preceding the predetermined financial forecast period. The personal and business financial data comprises commission, income and expense data. This process also comprises receiving personal and business financial goal data for the predetermined financial forecast period, the personal and business financial goal data comprising a production goal including a success ratio, calculating a financial forecast for the predetermined financial forecast period as a function of at least the commission, income and expense data, transmitting the financial forecast to the user, adjusting at least the commission goal, adjusting at least the income and expense data, accepting at least the commission goal and at least the income and expense data, calculating a financial budget for the predetermined personal and business financial forecast period as a function of the accepted commission goal and the accepted income and expense data, and generating a monthly worksheet for the predetermined financial forecast period as a function of the accepted commission goal and the accepted revenue and expense data. This method may preferably include adjusting the success ratios.

### BRIEF DESCRIPTION OF THE DRAWINGS

For purposes of illustrating various aspects of the invention and to provide a further understanding of the method and system of the invention, together with the detailed description, the drawings show forms that are presently preferred, it being understood, however, that the invention is not limited to the precise arrangements and instrumentalities shown, wherein:

FIG. 1 is a block diagram illustrating one example of a computer system suitable for computing personal and business financial forecasts and/or budgets in accordance with one or more aspects of the present invention;

FIG. 2 is a block diagram illustrating an example of a computer network system suitable for computing personal and business financial forecasts and/or budgets in accordance with another aspect of the present invention;

FIG. 3 is a flow diagram illustrating process steps and/or functions that may be utilized to calculate personal and business forecasts and budgets;

FIG. 4 is an example of a start up or home screen that may be utilized in accordance with one or more aspects of the present invention to inform the user of the steps toward creating a personal and business financial forecast and budget.

FIG. 5 is an example of a data entry screen that may be utilized in accordance with one or more aspects of the present invention for receiving personal expenses data from a user;

FIG. 6 is an example of a data entry screen that may be utilized in accordance with one or more aspects of the present invention for receiving business expenses data from a user;

FIG. 7 is an example of a data entry screen that may be utilized in accordance with one or more aspects of the present invention to receive data from a user relating to goal setting and financial forecasting predetermined timeline;

FIGS. 8A-8C are examples of data entry screens that may be utilized in accordance with one or more aspects of the present invention to receive a choice from the user as to which expense data are to be used as well as expense categories.

FIGS. 9A-9B are examples of computer screens that may be utilized in accordance with one or more aspects of the present invention to review data relating to financial goals in order for the user to decide if acceptable.

FIG. 10 is an example of a screen that may be utilized in accordance with one or more aspects of the present invention for requesting information about commission/units closed;

FIG. 11 is an example of a data entry screen that may be utilized in accordance with one or more aspects of the present invention to receive commission/units closed data;

FIG. 12 is an example of a data entry screen that may be utilized in accordance with one or more aspects of the present invention for receiving information relating to commission/units closed;

FIG. 13 is an example of a data entry screen that may be utilized in accordance with one or more aspects of the present invention for receiving commission/units closed data;

FIG. 14 is an example of a production goal screen in accordance with one or more aspects of the present invention;

FIGS. 15A and 15B are examples of screens or website pages requesting input for Listing and Selling Seasonality in accordance with one or more aspects of the present invention;

FIG. 16 is an example of a screen or a website page requesting that the user select his or her personalized prospecting methods in accordance with one or more aspects of the present invention;

FIGS. 17A and 17B are examples of screens or websites pages requesting information relating to inputting listing and selling prospecting data in accordance with one or more aspects of the present invention;

FIG. 18 is an example of a screen or a website page displaying the monthly goals worksheet of the user in accordance with one or more aspects of the present invention;

FIG. 19 is an example of a screen or website page for prompting the user to download charts and/or graphs relating to his or her monthly worksheets, budgets, forecasts, and the like;

FIG. 20 is an example of a screen or a website page displaying the user's monthly worksheet, including production goal information, listing seasonality, selling seasonality, goals and expenses in accordance with one or more aspects of the present invention; and

FIG. 21 is an example of a screen or a website page similar to that displayed in FIG. 20, where the expense information has been removed in accordance with one or more aspects of the present invention.

### DETAILED DESCRIPTION

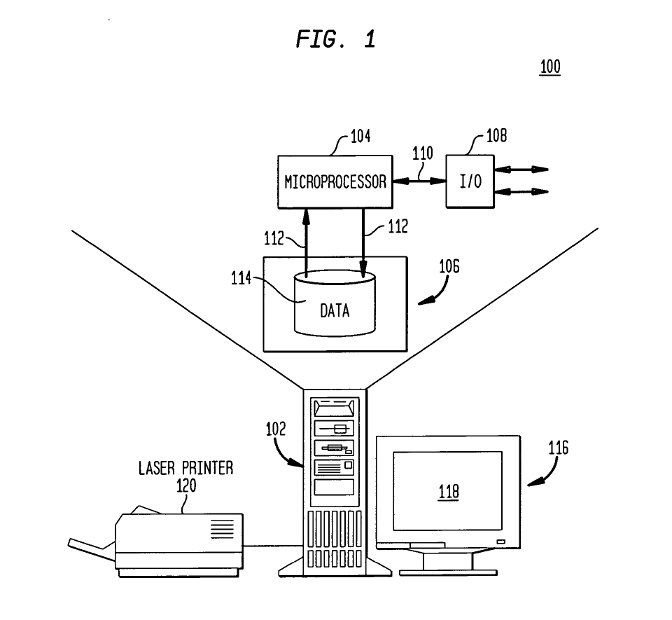

Referring now to the drawings, wherein like numerals indicate like elements, FIG. 1 depicts a block diagram illustrating an example of a system 100 for computing personal and business financial goals, forecasts and/or budgets in accordance with one or more aspects of the present invention.

The system 100 preferably includes a data processing unit 102, which includes but is not limited to a microprocessor 104, a memory storage device 106 and an input/output device 108. The microprocessor 104 is operatively coupled to the input/output device by way of a data and/or instruction bus 110 and operatively coupled to the memory 106 by way of a data and/or instruction bus 112.

The data processing unit 102 may be implemented utilizing any known hardware, such as one or more digital and/or analog microprocessors, at least one computer (such as a portable, stationary and/or distributed computing system), or any other known and/or hereinafter-developed data processing units. The memory 106 preferably includes databases 114 at least containing, for example, personal and business financial data. The databases 114 may include average production goal data received from an average of production goals, a database containing pre-calculated average data received from an average of production data from a plurality of users, a personal and business financial forecast and/or a financial budget database, success ratio data and the like.

The memory 106 may be implemented by way of separate hardware or may be disposed within the data processing unit 102. Any known hardware, firmware and/or software for implementing the databases 114 may be employed. Data are preferably input to, and output from, the data processing unit 102 by way of input/output device 108 that is operatively coupled to a display/data input device 116. By way of example only, the display/data input device 116 may include a display screen 118, such as any commercially available CRTs, LCDs, plasma, etc. The display/data input device 116 may also include any commercially available input devices, such as a touch screen, a pointing device, a keyboard, a mouse, a voice recognition system, and the like.

A user of the system 100, by way of example only, a real estate agent (hereinafter “agent” or “user”), preferably utilizes the display/data input device 116 to provide information to and through the data processing unit 102 by way of the input/output device 108 to facilitate the computation of one or more personal or business financial goals, forecasts and/or budgets in accordance with one or more aspects of the present invention. The data processing unit 102 preferably provides information concerning personal and business financial goals, forecasts and/or personal and business financial budgets to the user by way of the display/data input device 116. The agent may also receive such information by way of a printer 120.

It is noted that the term “real estate agent” is used broadly to include one or more individuals, one or more real estate agents, or other sales representatives, and the like.

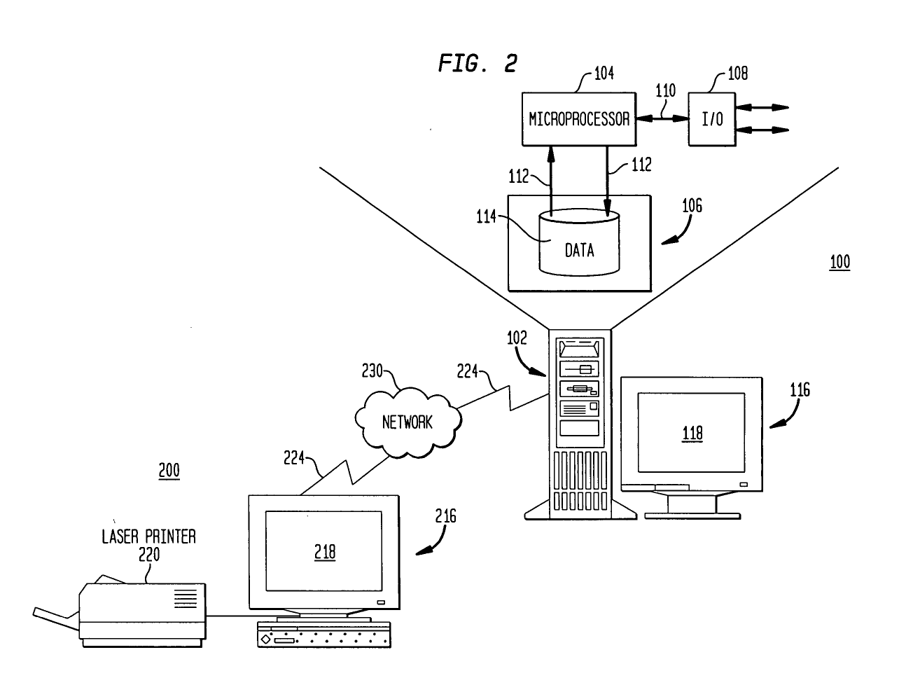

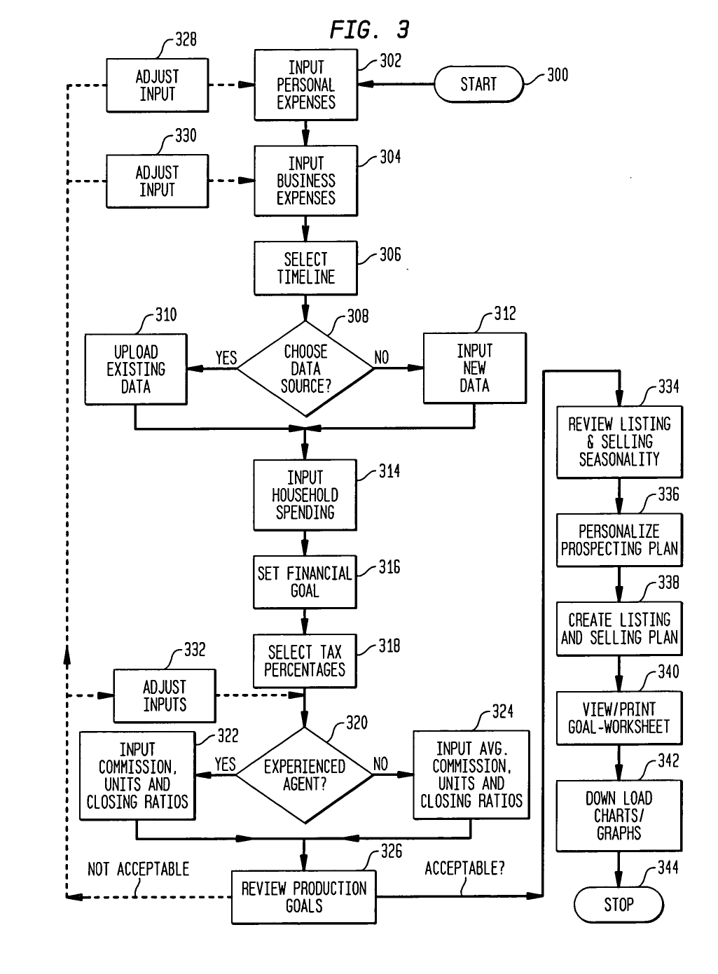

It is also noted that the functional blocks illustrated in FIG. 1 may be partitioned as shown or may be partitioned in any other way, such as in an integral fashion. By way of example only, the system 100 may be implemented utilizing a portable, stationary, or distributed computer operating under one or more suitable computer programs. Further, with reference to FIG. 2, the system 100 may be remotely located from a user's display/data input device 216, such as in a distributed (e.g., networked) system as shown.

For example, a separate display/data input system 200 including display/data input device 216, display screen 218 and printer 220 may be remotely located from the other elements within the functional blocks of the system 100, where the link 224 between the display/input system 200 and the system 100 may include an electronic communications network 230, either hardwired or wireless, such as a local area network (LAN), wide area network (WAN), Ethernet or the Internet or any other network capable of transmitting and receiving data. In this particular arrangement, the data processing unit 102 may operate as a server, preferably a web based server, used in the network 230 by many users being represented by system 200.

Irrespective of how the local system 100, or as that system is remotely coupled to system 200, is implemented and/or partitioned, it preferably carries out a method for calculating and reporting personal and business financial forecasts and/or financial budgets data for a user or users in accordance with one or more aspects of the present invention such that production goals, personal and business financial forecast, financial budgets and the like are obtained.

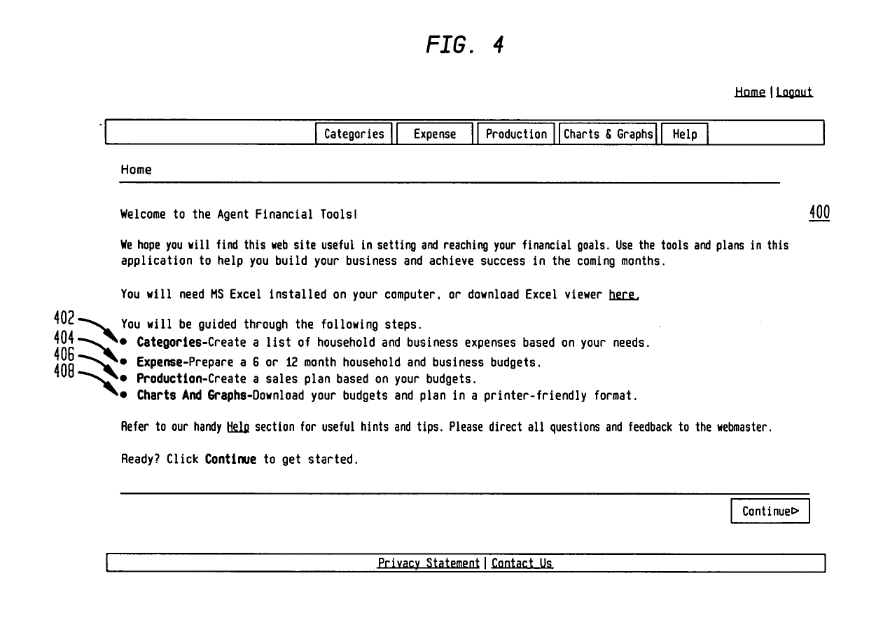

To this end, reference is made to FIG. 3, which is a flow diagram illustrating at least some of the steps and/or functions of a preferred method in accordance with aspects of the present invention. At action 300, for example, an agent preferably begins a personal and business financial forecast and/or budget session by logging onto a financial planning program to provide data to the data processing unit 102 using display/data input device 116. By way of example, the agent may alternatively log onto a website through the display/data input device 216 as described with respect to FIG. 2, the website displaying a welcoming page of the financial planning platform as illustrated in FIG. 4. The user may also re-enter a website, upload a version of a previous session that has been edited and work with a revised plan. Any known processing or graphic user interface techniques for creating computer data input screens or website pages (e.g., page 400) might be employed without departing from the spirit and scope of the invention.

At action 300, the user is prompted by a welcoming screen 400 (FIG. 4) to begin. The screen then informs the user that he or she will be guided through at least the following steps: (1) at category step 402, the user will be prompted to create a list of household (or personal) and business expenses based upon needs; (2) at the expense step 404, the user will be prompted to prepare household (personal) and business budgets for a predetermined amount of time; (3) at the production step, the user will be prompted to create a sales plan based upon the user's budgets; and (4) at the charts and graphs step, the user will be prompted to download the budgets and production plan including success ratios, if appropriate.

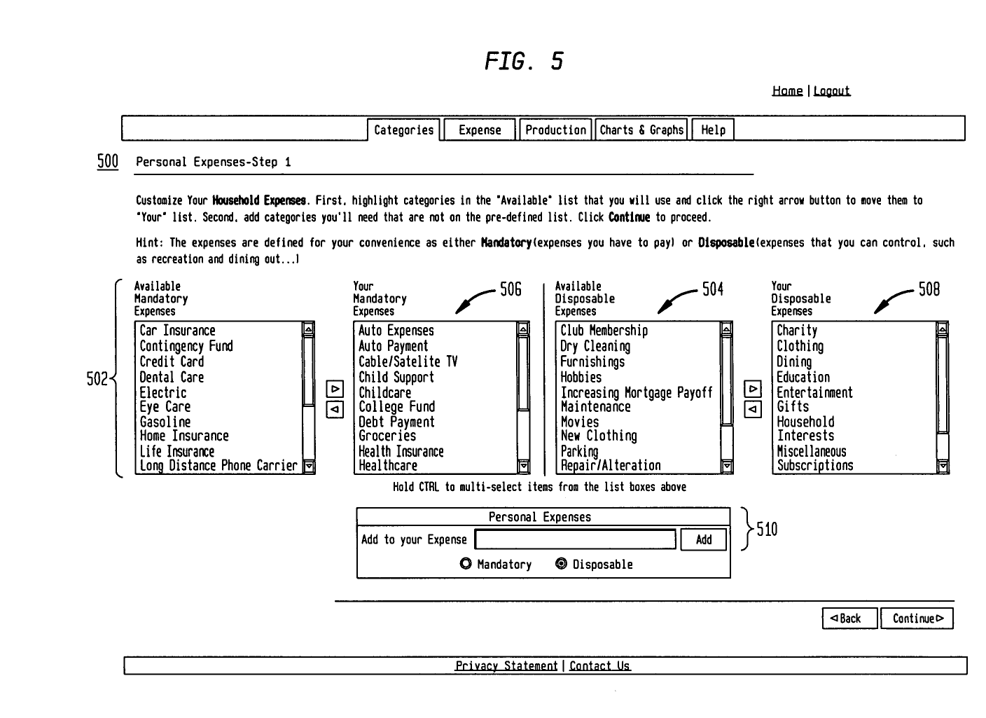

At action 302 of FIG. 3, the agent is prompted to select or input personal expense information. In the illustrated example of FIG. 5, the personal expenses set up screen includes a plurality of fields, here in the form of drop down, click down or scroll down fields, including a list of “available mandatory expenses” 502 and a list of “available disposable expenses” 504. From these two scroll down lists, the user is prompted to populate the adjacent two expense fields, respectively. The first is the “your mandatory expenses” field 506, which corresponds with the “available mandatory expenses” field 502. The second is the “your disposable expenses” field 508, which corresponds with the “available disposable expenses” field 504.

Thus, a user is prompted to highlight the categories in the available lists that the user will need for his or her forecasting and budget calculations. The user is then prompted to move these highlighted items to the users (“Your”) lists. In addition, the user is prompted to add any categories that are not on the pre-defined list for either the available mandatory expenses 502 or the available disposable expenses 504. A preferable field is located on this same personal expenses website page 500, which allows the user to add his or her expenses 510.

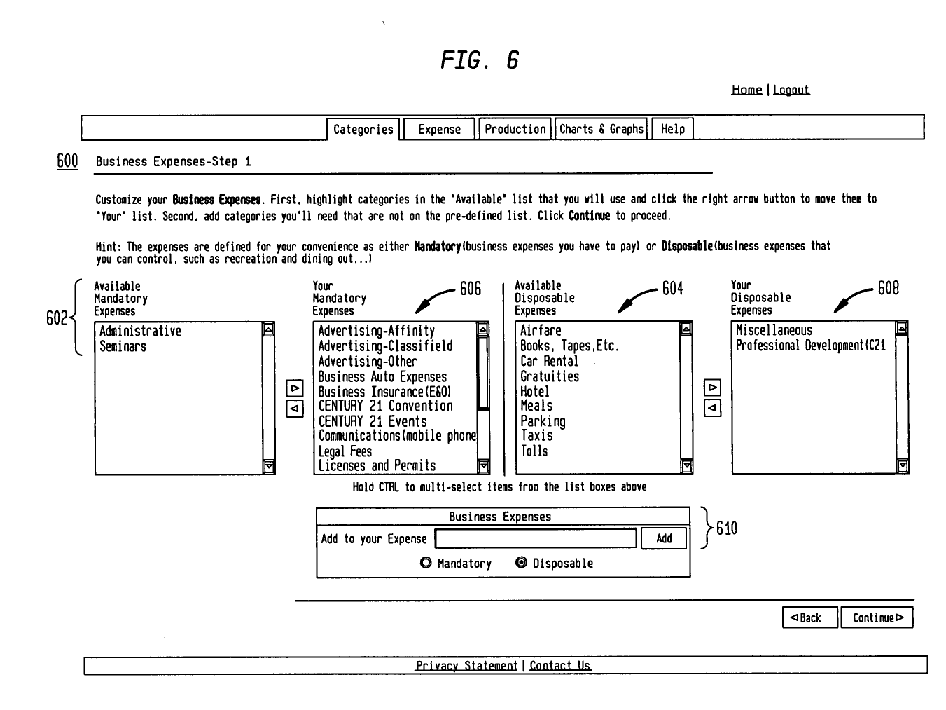

Similarly, at action 304 of FIG. 3, the agent is prompted to input, populate or enter his or her business expenses. In the illustrated example of FIG. 6, the business expenses screen 600 displays similar drop down, click down or scroll down fields, which are capable of being used for assisting the agent is choosing the “available mandatory expenses” and “available disposable expenses.” Similar to the screen shot shown FIG. 5, the business expenses exemplary website page 600 includes an “available mandatory expenses” field 602, an “available disposable expenses” field 604, a “your mandatory expenses” field 606 and a “your disposable expenses” field 608 for population. Again similar to the personal expenses input fields, this preferred screen includes a field for populating business expenses not included on the provided available lists of business expenses 610.

At action 306 of FIG. 3, the agent is prompted to set a timeline. Once entered, this becomes the predetermined forecast period from which all forecast and budgetary data is calculated for that particular planning session. It is to be noted that if the user does not complete the planning session until a later time, the system can save the data already entered. For privacy issues, the system may optionally not store certain personal data of the user such as personal expenses, if prompted to do so. For example, if the user wishes to transmit its worksheet to a manager, he/she may want to exclude the personal expense data.

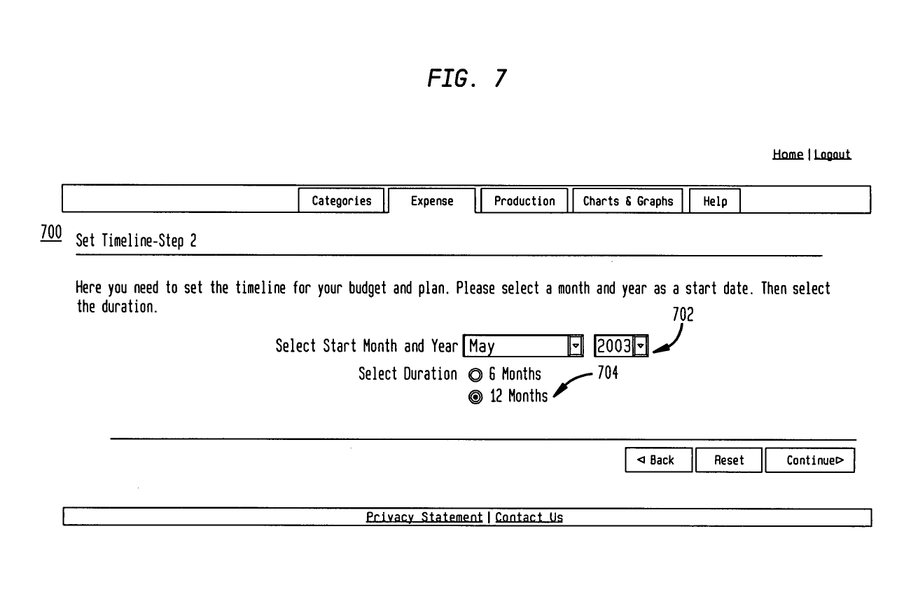

In the illustrated example of FIG. 7, the setup screen includes a plurality of fields, here in the form of drop down, click down or scroll down fields, including a “month” data entry field and a “year” data entry field, which prompts the agent to populate these fields with the beginning date of a forecast period to be calculated. In this particular example, the agent has chosen May 2003. A forecast period of either six months or twelve months (one year) is generally selected. Here, twelve months has been selected. However, any predetermined period, expressed in months, years or any other period designating unit of measurement is contemplated and would not depart from the spirit and scope of this invention.

Referring again to FIG. 3, in preferably a different screen or website page, at action 308, the agent is prompted to choose a data source and enter his or her financial data or results from an existing database. The agent may enter these results manually or direct the data processing unit 102 to retrieve such data from a separate storage area accessible by the data processing unit 102. For example, a user may have previously stored his or her expenses on an interactive spreadsheet, such as an EXCEL spreadsheet file.

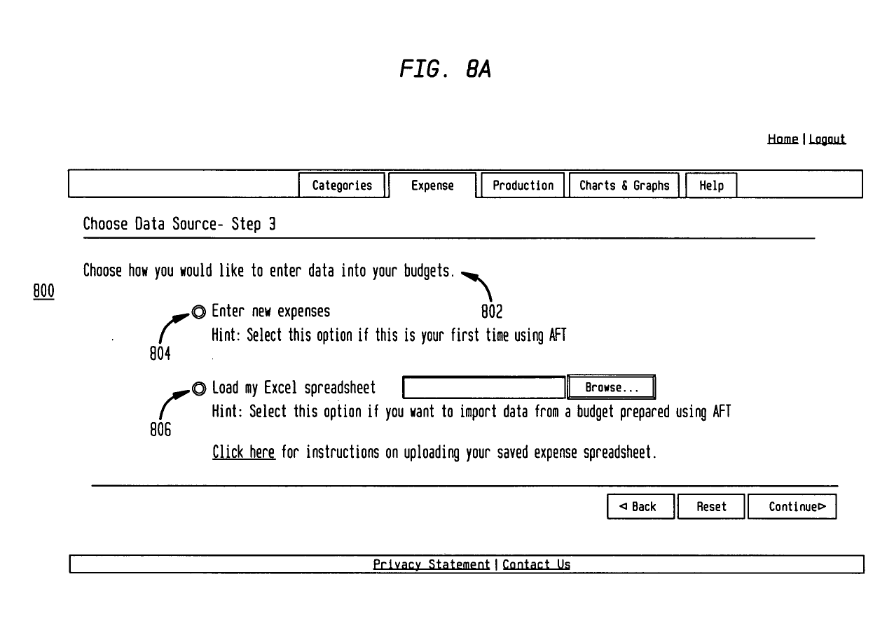

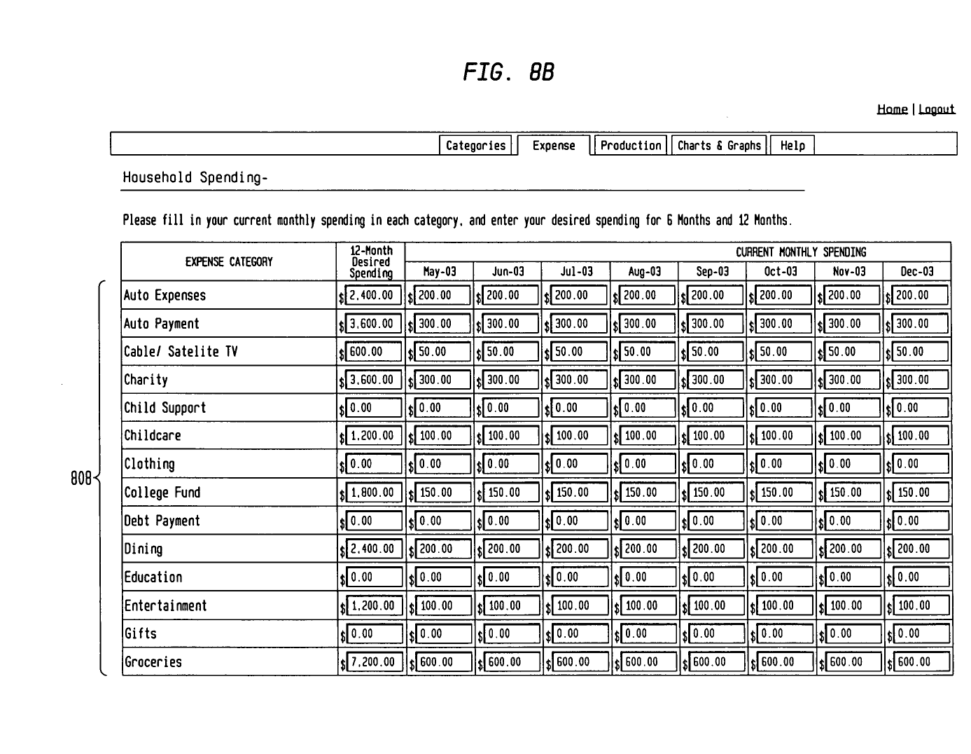

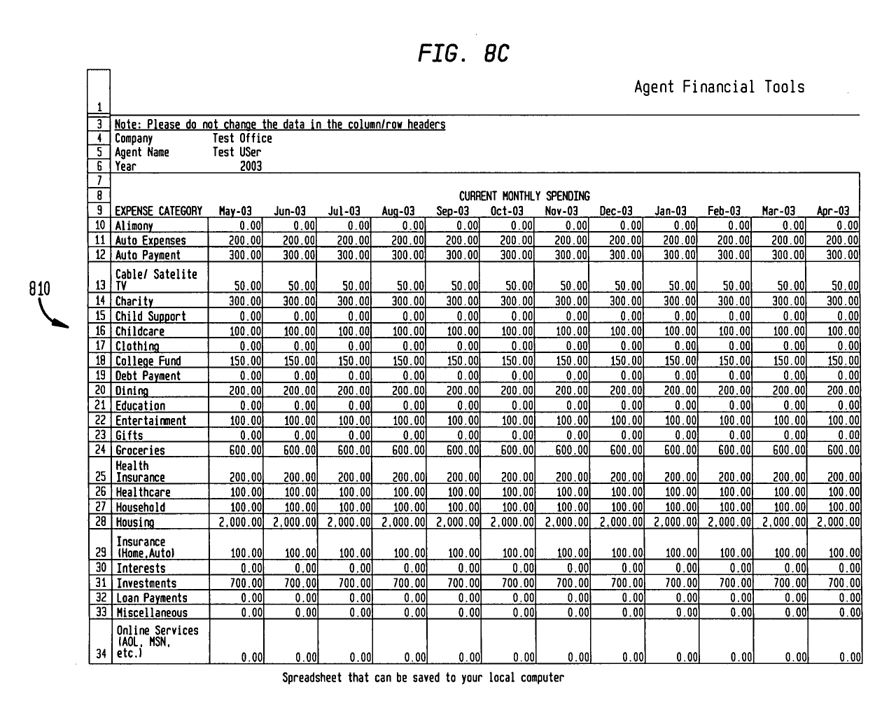

FIGS. 8A-8C are illustrative examples of screens or web pages utilized by the agent to enter his or her expense information. Turning now to FIG. 8A, the agent is prompted through a textual script 802 to choose how the user would like to enter expense data into the budgets, either by entering new expenses 804 or by importing data from a budget previously prepared, using average production goal data 806. Turning now to FIG. 8B, the user is prompted to populate the data entry fields as shown in 806. The type and number of fields in all examples of screens and website pages are by way of example only. More or less fields are contemplated by this invention and the addition or absence of such fields would not depart from the spirit and scope of this invention.

As illustrated in FIG. 8B, the user is prompted to enter household expenses. In this particular illustration, the agent enters current monthly spending in various amounts for each expense, including but not limited to auto expenses, auto payment, cable/satellite TV, charity, and the like. As shown in FIG. 8C, the total monthly expenses 810 has been calculated, which can then be saved to the user's local computer.

The agent is then prompted to confirm that all data received or automatically inputted is correct and if so for the agent to save the information to the user's data processing unit 102. Once the information has been saved, it can later be retrieved to complete or revise the process of calculating a financial goal, forecast and/or financial budget.

Returning again to FIG. 3, if the agent has performed the above task, the data obtained and calculated is then uploaded at step 310 and household spending is inputted at step 314 to the data processing unit 102. If, on the other hand, the agent is new and therefore has no financial history, the data processing unit 102 will preferably request information at step 312, as discussed above. Thus, the data processing unit 102 receives either information 314 of the individual agent for the first time or data uploaded from a previous session.

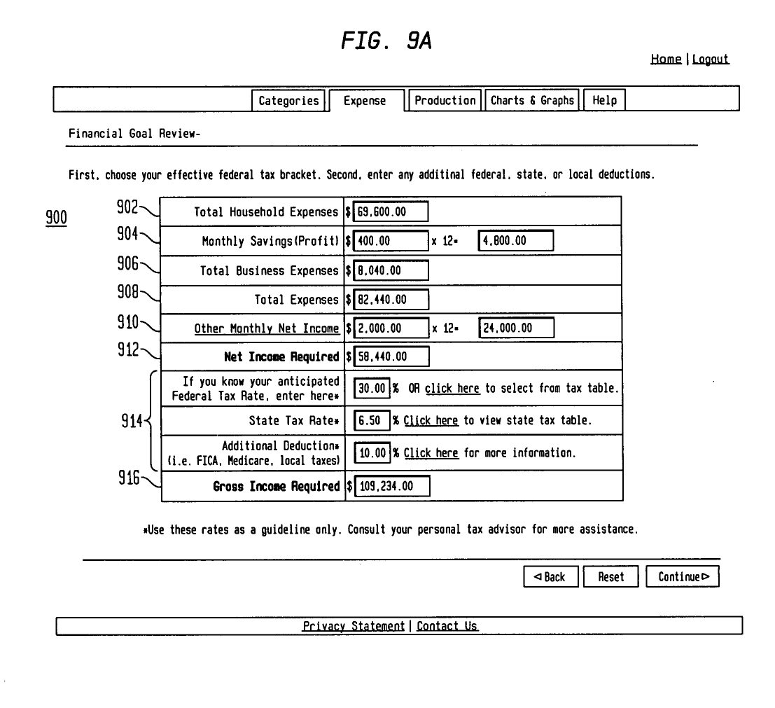

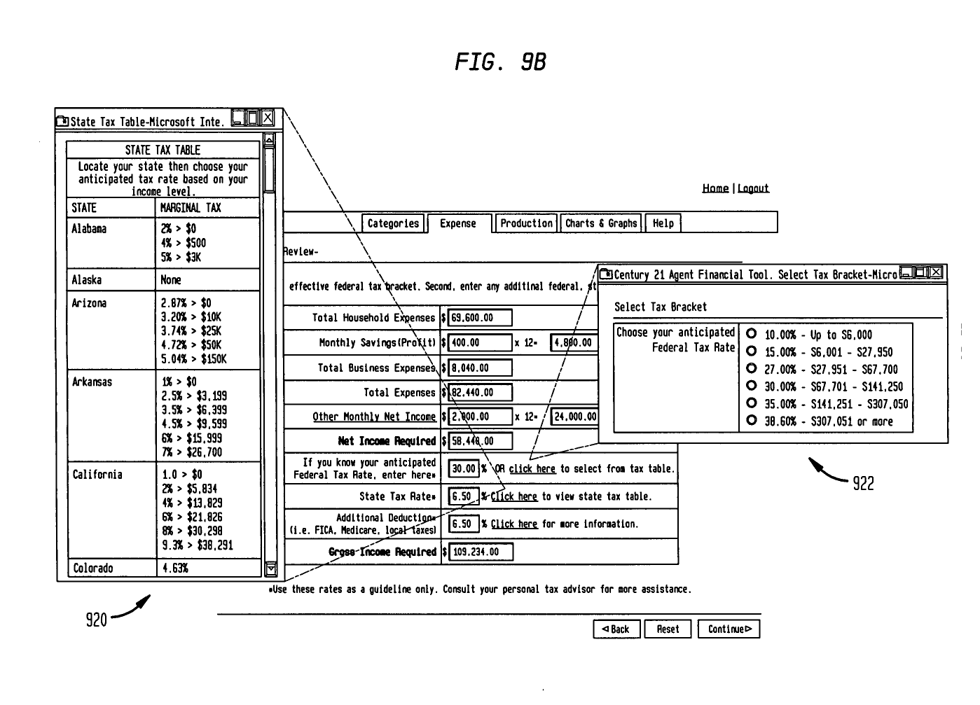

At action 316, the user is prompted to review and set his or her financial goal. As illustrated in FIG. 9A, the agent is prompted to review the Total Household Expenses field 902, the Monthly Savings field 904, the Total Business Expenses field 906, and the Total Expenses field 908. The user is then prompted to input other monthly net Income 910, if appropriate. In this particular example, the adjusted net income 912 is displayed. Once this data has been inputted and calculated, at action 318, the user is prompted to enter his or her tax information 914, which may include federal tax rate, state tax rate and additional deductions. The data processing unit 102 then calculates the Gross Income Required 916.

FIG. 9B illustrates “help” dialog boxes for assisting the user in determining the federal and state tax rates. For example, dialog box 920 displays an alphabetical listing of the state tax table and dialog box 922 displays the federal tax rate, both based upon income.

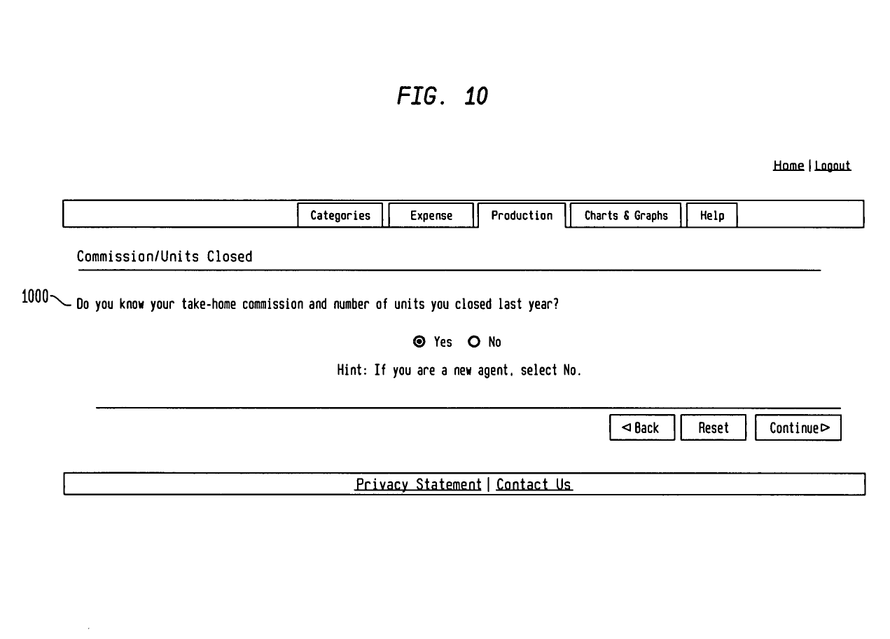

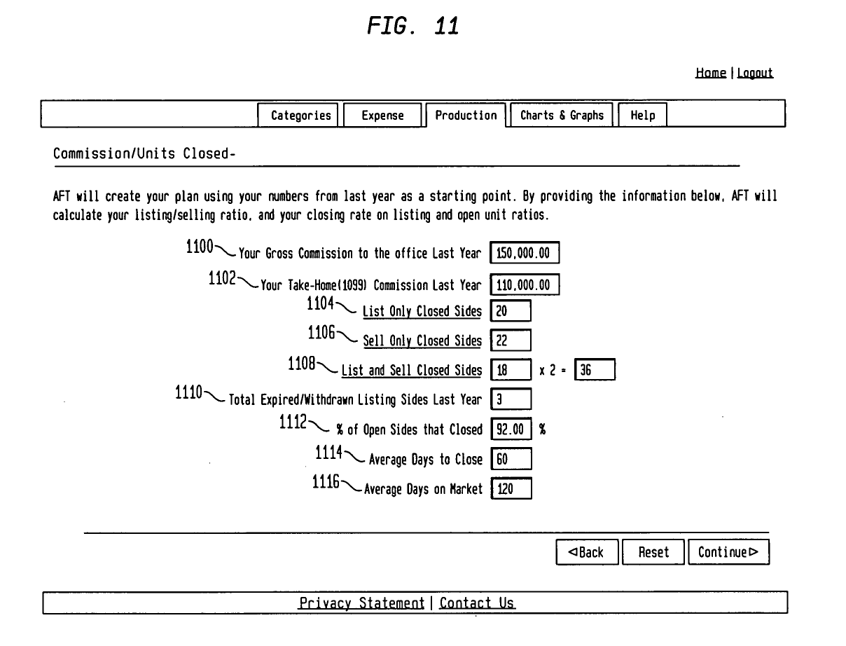

Referring again to FIG. 3 at step 320, the user is prompted to input whether he or she is an experienced agent. Specifically as illustrated in FIG. 10, the user is asked whether he or she knows his or her take home commission and number of units closed for the previous period, here, one year 1000. If the agent is new, he or she is prompted to select “No.” If on the other hand, the agent is not new, at step 322, and as illustrated in FIG. 11, in a preferred embodiment, the system will create a plan using numbers from the previous period as a starting point. Specifically, the system of a preferred embodiment of the present invention would input the gross commission to the office 1100, the user's take home commission 1102, the “list only” closed sides 1104, the “sell only” closed sides 1106 and the “list and sell” closed sides 1108. Furthermore, the system will include the total expired/withdrawn listing sides last year 1110, and the percentage of open sides that closed 1112.

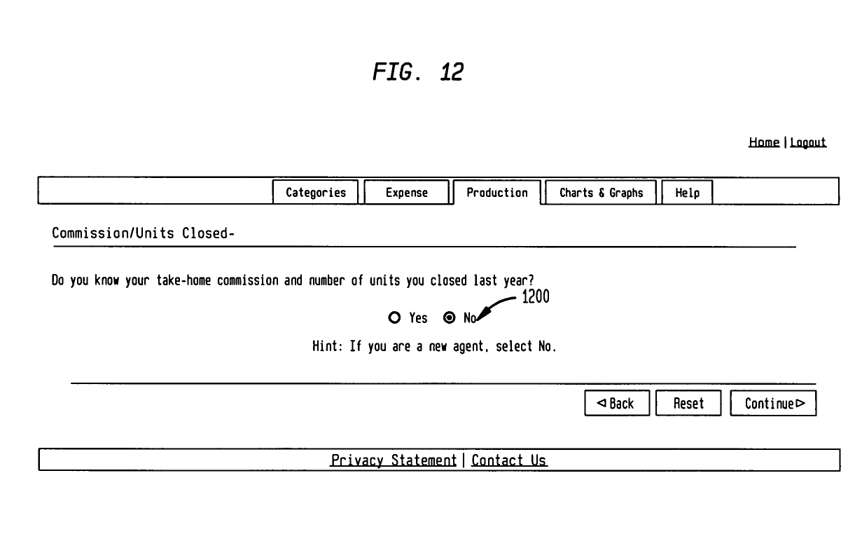

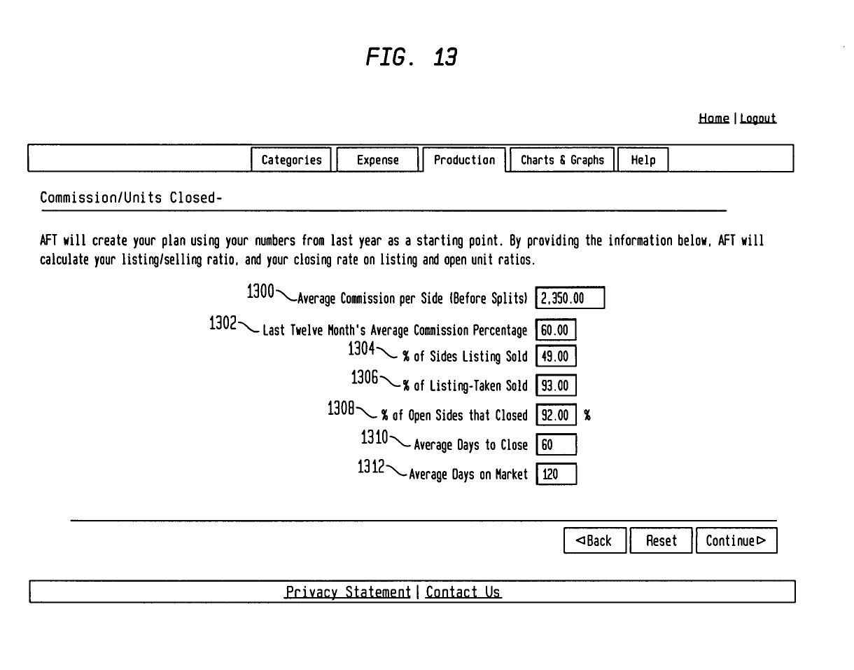

In this illustrative example, the system will also input the average days to close 1114 and the average days on market 1116 for this particular user or users. If, as illustrated in FIG. 12, the agent is new, he or she is prompted to click “No” 1200. Then, at step 324 and with reference to FIG. 13, the system will input average commissions, units and closing ratios. Specifically, with reference to FIG. 13, the system will calculate the average commission per side 1300, the last twelve months average commission percentage 1302, the percentage of sides listing sold 1304, the percentage of listing-taken sold 1306, the percentage of open sides that closed 1308, the average days to close 1310, and the average days on market 1312.

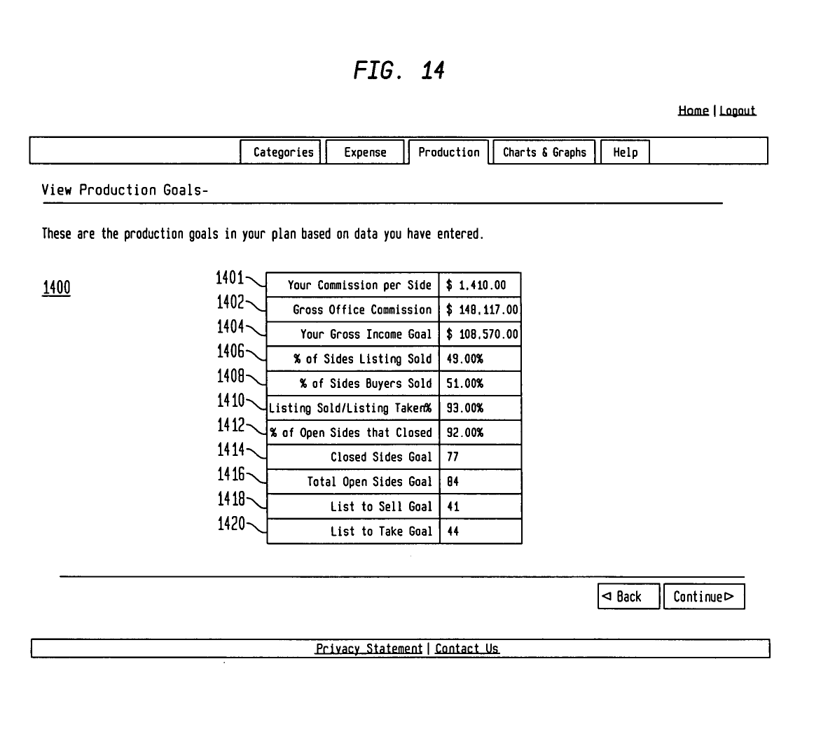

At step 326, the user is then prompted to view or review his or her production goals 1400. This is best illustrated in FIG. 14. Specifically, the information reviewable by the user is based upon the data that has been entered either by the user in the initial session or from previous information entered and uploaded for purposes for calculating production goals 1400.

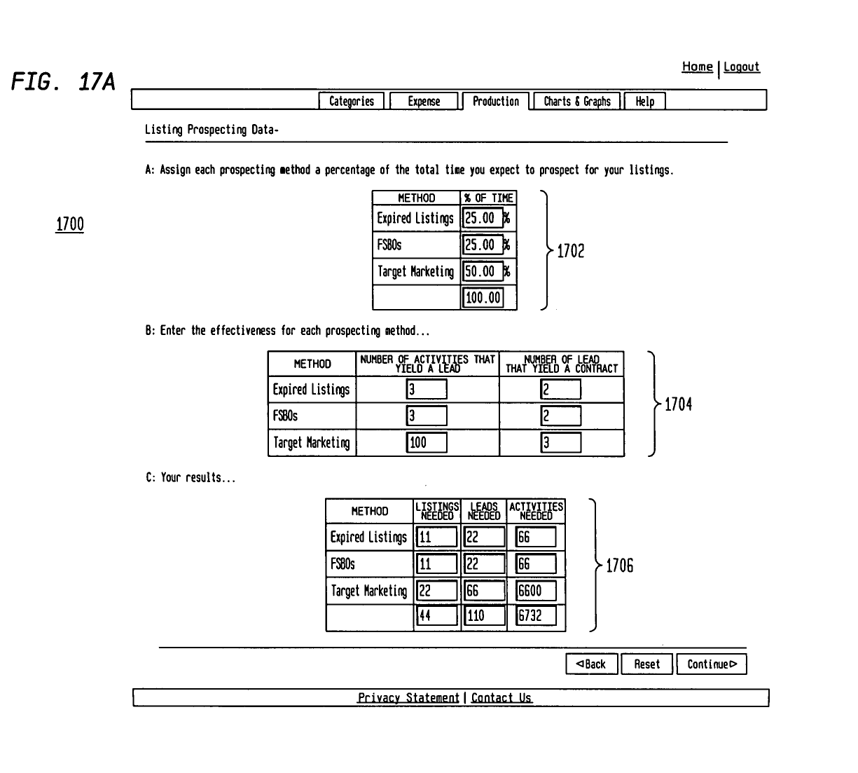

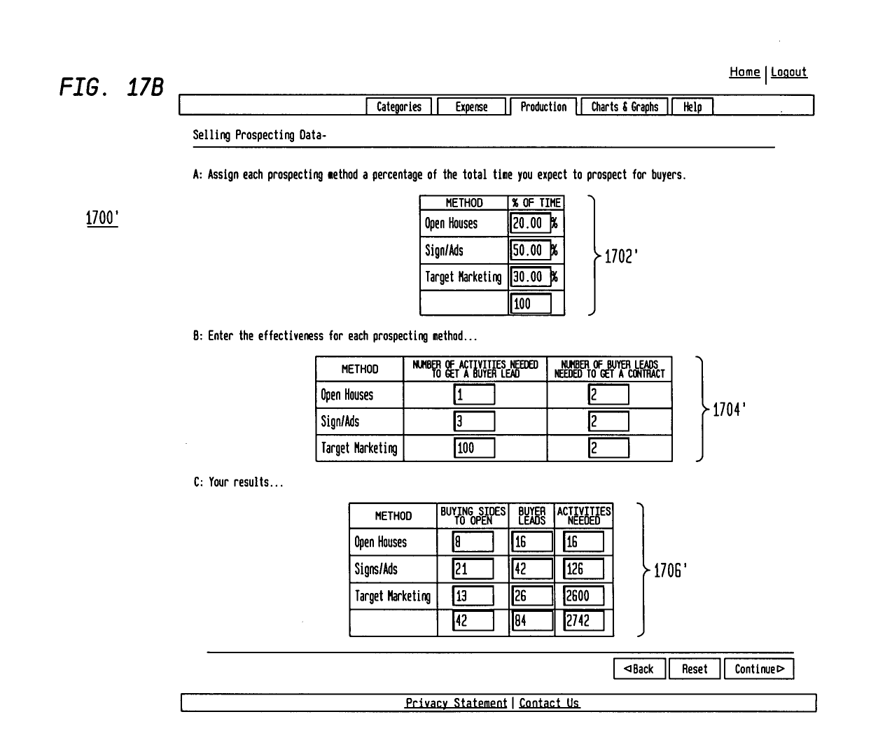

By way of example only, the production goals 1400 include, but are not limited to, commission per side 1401, gross office commission 1402, gross income goal 1404, percentage of sides listing sold 1406, percentage of sides buyers sold 1408, listing sold/listing taken percentage 1410, percentage of open sides that closed 1412, closed sides goal 1414, total open sides goal 1416, lists to sell goal 1418 and lists to take goal 1420. The production goal may also include success ratios as described in FIGS. 17A and 17B. Once the commission/units closed has been entered, the user is prompted to review the production goals 1400 as a function of all the previously entered information.

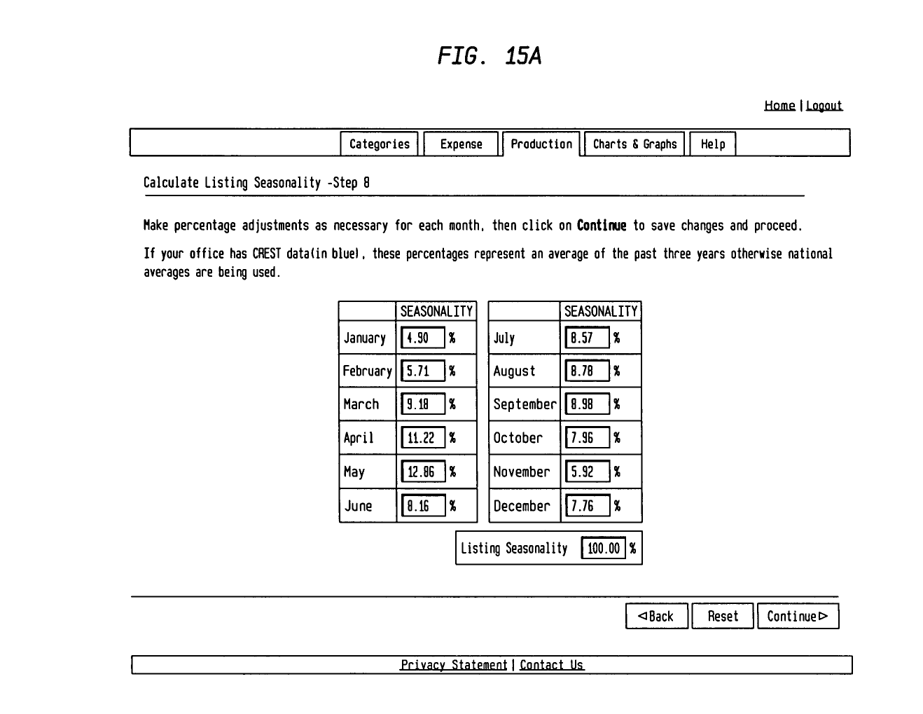

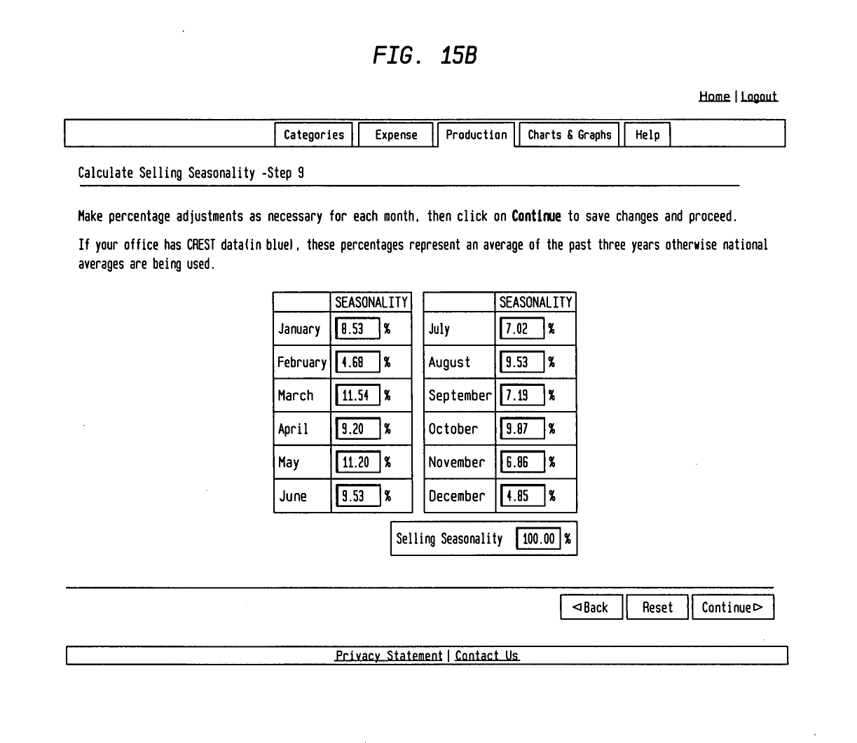

If, for example, the production goals are acceptable, the user continues with inputting further information. If, on the other hand, the production goals are not acceptable by the user, the user is given an opportunity to return to the data entry screens relating to the expenses and/or commissions/units closed, and at actions 328, 330 and 332, the user is prompted to adjust the data inputs. Once the adjustments have been made, the user is prompted to review the production goals again. If the production goals are acceptable to the user, the next step preferably is for the user to review his or her listing and selling seasonality as shown at action 334 and with reference to FIGS. 15A and 15B.

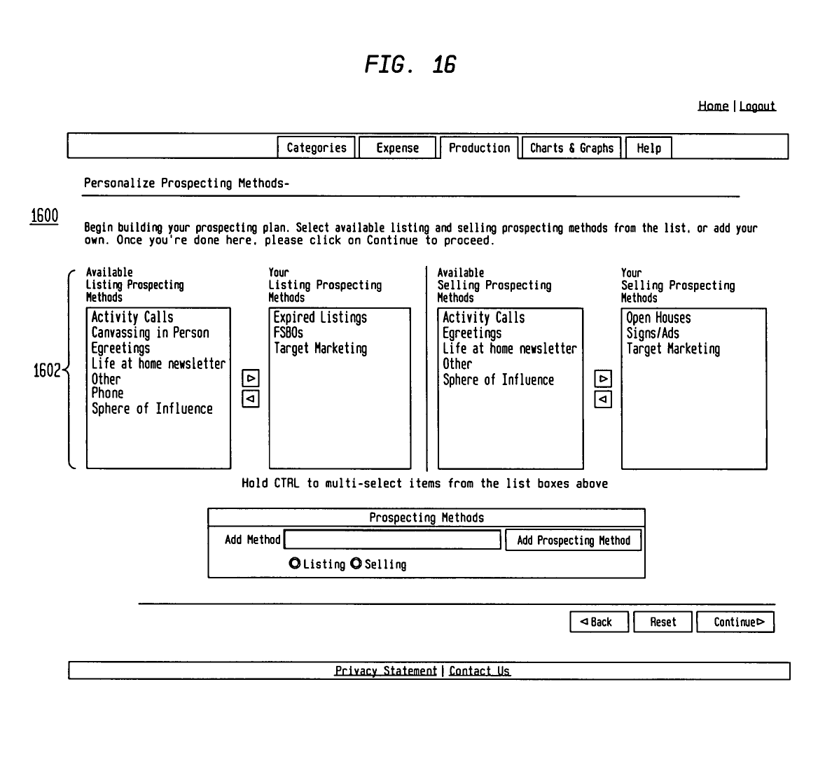

The production goals 1400 may consist of a commission goal or an expense goal or perhaps even an income goal. The user may also adjust the success ratios, as discussed below with respect to FIGS. 16-17B. It has been realized that if the agent inputs a commission goal, for example, he or she cannot merely rely upon a forecast that suggest the agent increase only income to achieve the chosen commission goal. Instead, one aspect of the present invention achieves a desired commission goal by increasing expenses both personal and business, perhaps. That is, to achieve a certain commission percentage for a predetermined financial forecast period, one may have to actually increase its expected expenses for the defined period of interest. Therefore, while inputting, for example, a commission goal, the method in accordance with certain aspects of the present invention also asks the user to review income and expense figures. Then, in accordance with certain aspects of the present invention, the user is prompted to enter a goal, for example, a production goal. The user may be prompted to enter success ratios as well.

Preferably, after the user has adjusted his or her expenses and/or income estimates and the commission goal, the production goal is set and reviewable by the user. Once entered, the data processing unit 102 will once again calculate whether the commission goal is commiserate with the projected income stream and personal and business expenses. If unrealistic based upon income and expense figures, the user is prompted again to subsequently revisit this screen or web page to adjust the figures accordingly.

Specifically, if the commission goal is unrealistic based upon the income and personal and business expense figures, the user will be notified to either 1) modify his or her commission goal or expectations or 2) modify his or her personal and business expenses, or perhaps income, goals or 3) modify success ratios, in an attempt to achieve the desired production goal. Ultimately, the agent will be informed as to what income is expected (keeping in mind personal and business expenses as well) to achieve the projected commission goal.

In a very particular embodiment, the agent will be informed as to how many properties, for instance, and at what price levels, he or she must close those real estate deals in order to reach his or her annual production goal.

Once the goals have been entered, the data processing unit 102 adjusts at least for the personal and business expense forecast. Referring again to FIG. 3, at action 336, the agent is prompted to personalize his or her prospecting methods, including selecting listing and selling prospecting methods. FIG. 16 is an illustrative example of these fields and screen or website pages. FIG. 16 depicts a screen or website page 1600 that is preferably used by agents wanting to choose from a predetermined list as well as inputting his or her own methods.

At action 338, the agent is prompted to input listing prospective data 1602. That is, for example, as best shown in FIG. 17A, the agent is prompted to assign each prospecting method a percentage of the total time expected to prospect for buyers 1702. Then, the agent is prompted to enter the effectiveness for each prospecting method 1704. Finally, the data processing input 102 calculates the agent's results 1706. These results may be expressed in the form of success ratios. These results may include, but are not limited to, the following methods: open houses, Signs/Ads and Target Marketing.

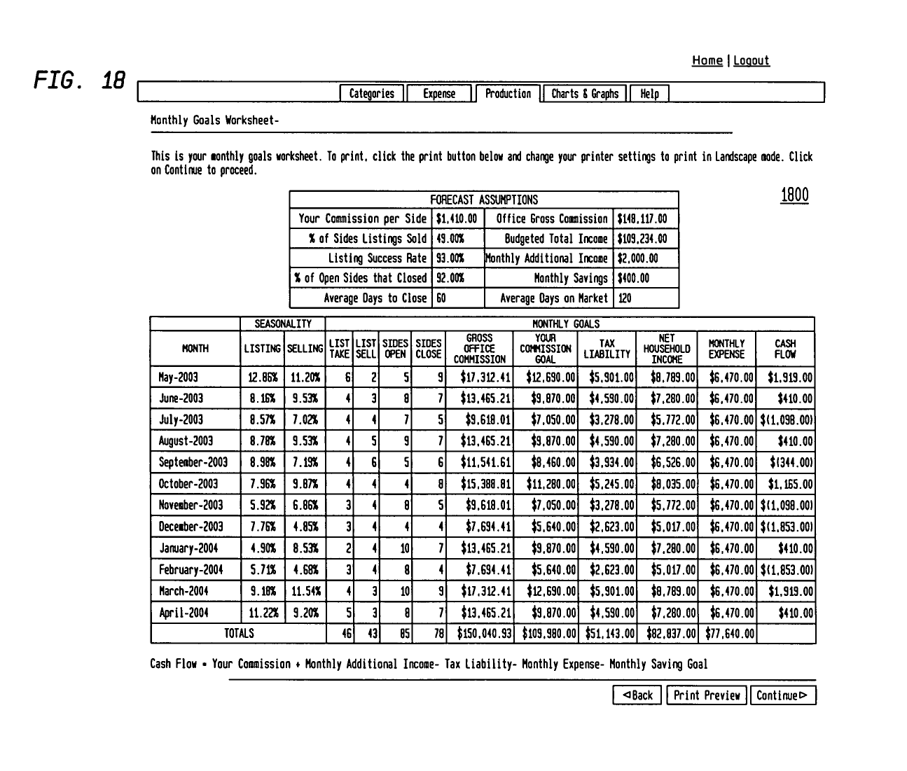

At action 340, and as shown in FIG. 18, the user is provided with a monthly goals worksheet, in accordance with one or more preferred embodiments of the present invention. In this particular example, the data processing unit 102 computes and reports (in the form of charts, graphs and the like) the forecast assumptions, seasonality and monthly goals.

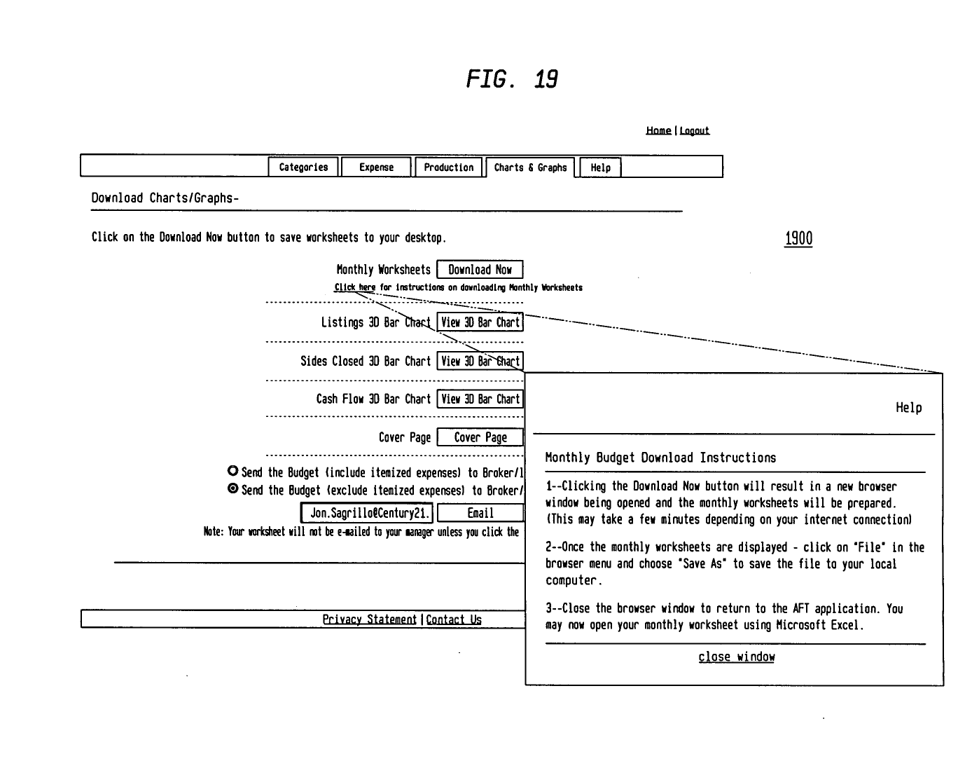

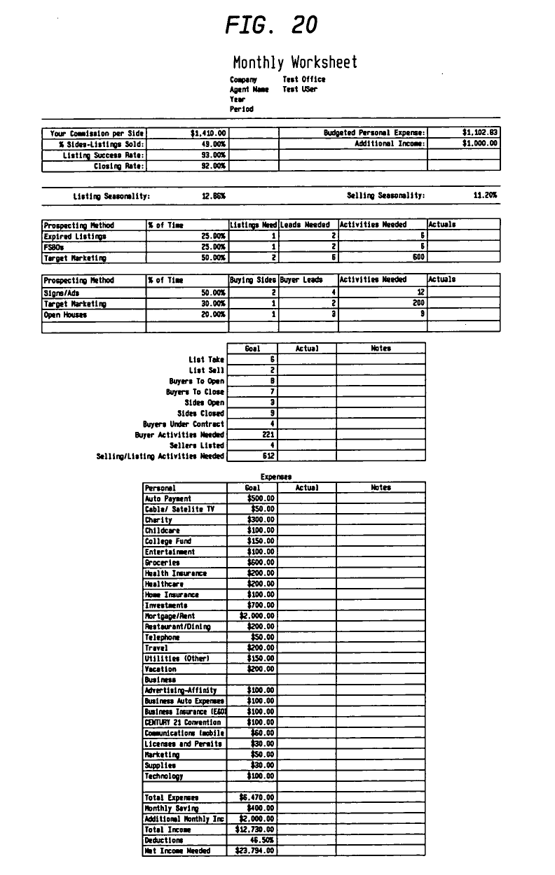

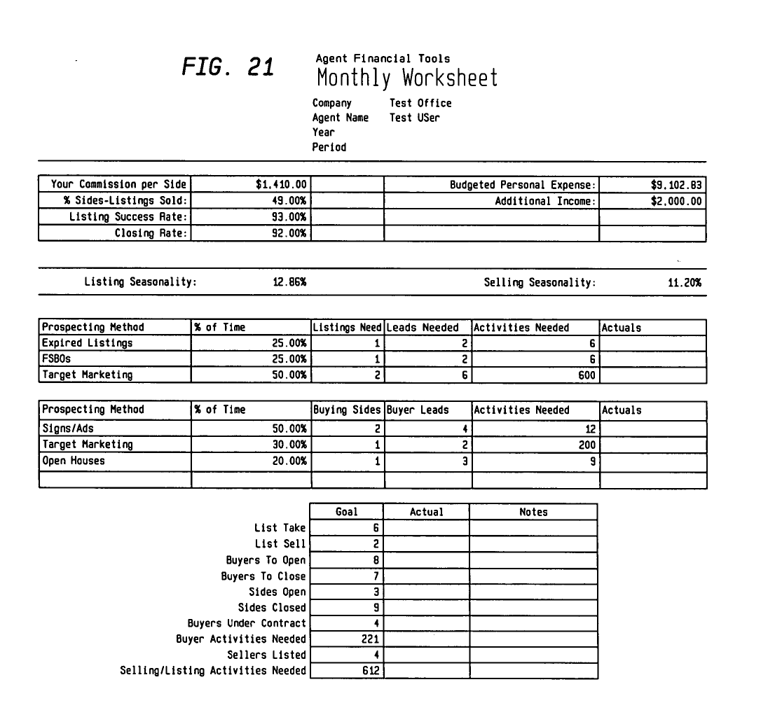

As best shown in FIG. 19 and at action 342, the data processing unit 102 prompts the user to download the monthly worksheet that it generated. This illustrative webpage screen 1900 also allows the user to download listings, sides closed and cash flow information. FIG. 20 is an example of a monthly worksheet, including the agent's expenses. Alternatively, the user may print out a monthly worksheet without displaying expenses, as shown in FIG. 21. This is important when the agent does not wish to share his or her personal expenses with his or her superiors such as brokers.

Once the agent has completed his or her session and has received a financial goal, production goal, forecast and/or a budget, monthly worksheets, charts, graphs, etc., the agent may forward such information to a third party such as a manager or a recipient of his or her choice. Then, the user may log off the system at action 344.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of providing to a user a personal and business financial forecast for a predetermined forecast period, comprising:
receiving past personal and business financial data from a period preceding the predetermined forecast period;
receiving personal and business financial goal data for the predetermined forecast period; and
calculating a personal and business financial forecast for the predetermined forecast period as a function of said past personal and business financial data and said personal and business financial goal data.

2. The method of claim 1, wherein said step of receiving past personal and business financial data comprises receiving at least a portion of said past personal and business financial data from calculated results of an average of production goal data of user-provided data.

3. The method of claim 2, wherein said production goal data comprises user-provided data taken from a group comprising: success ratios; average commission; last predetermined period's average commission percentage; percentage of sides listing sold; percentage of listing-taken sold; percentage of open sides that closed; average days to close; and average days on market.

4. The method of claim 1, wherein said step of receiving past personal and business financial data comprises receiving at least a portion of said personal and business financial data from a pre-calculated average.

5. The method of claim 4, wherein said pre-calculated average comprises an average of user-provided data from a plurality of users, taken from a group consisting of: average commission; last predetermined period's average commission percentage; percentage of sides listing sold; percentage of listing-taken sold; percentage of open sides that closed; average days to close; and average days on market.

6. The method of claim 1, wherein said past personal and business financial data comprises success ratios, commission, income and expense data from said past period preceding the predetermined forecast period.

7. The method of claim 1, wherein said personal and business financial goal data comprises a production goal.

8. The method of claim 7, wherein said forecast data comprises forecasted income and personal and business expense data necessary to achieve said production goal.

9. The method of claim 8, further comprising reporting said forecast to the user.

10. The method of claim 9, further comprising adjusting said personal and business financial goal data.

11. The method of claim 10, wherein said step of adjusting said personal and business financial goal data is a function of adjusting data taken from a group comprising:
(i) listing seasonality; and
(ii) selling seasonality.

12. The method of claim 1, wherein said period preceding the predetermined forecast period is at least one year.

13. The method of claim 9, wherein said past personal and business financial data comprises success ratio data, commission, income and expense data from said past period preceding the predetermined personal and business financial forecast period, said financial goal data comprising a production goal, said financial forecast comprising income and expense data, and said method further comprising adjusting said production goal.

14. The method of claim 10, further comprising adjusting any one of said success ratio data, income data or expense data.

15. The method of claim 10, further comprising accepting any one of said success ratio data, income data or expense data.

16. The method of claim 10, further comprising adjusting any one of said success ratio data, income data or expense data, and accepting either one of said success ratio data, income data or expense data.

17. The method of claim 15, further comprising calculating a personal and business financial budget for the predetermined forecast period as a function of said production goal data and said accepted any one of said success ratio data, income data or expense data.

18. The method of claim 15, further comprising generating a monthly worksheet for the predetermined financial forecast period as a function of said financial goal data and said accepted any one of said success ratio data, income data, or expense data.

19. The method of claim 1, wherein the method is computer-assisted using a data-programming unit and at least partly performed over a network between the user and said data-processing unit.

20. The method of claim 19, wherein said network is at least partially coupled to the Internet.

21. A computer system for providing to a user a personal and business financial forecast for a predetermined forecast period, the computer system including at least one data-processing unit operable to execute one or more executable programs, the one or more executable programs causing the at least one data-processing unit to perform steps comprising:
receiving past personal and business financial data from a period preceding the predetermined forecast period;
receiving production goal data for the predetermined forecast period; and
computing a personal and business financial forecast for the predetermined financial forecast period as a function of said past personal and business financial data and said production goal data.

22. The computer system of claim 21, wherein said step of receiving past personal and business financial data comprises receiving at least a portion of said past personal and business financial data from calculated results of an average production goal, said average production goal including user-provided data.

23. The computer system of claim 22, wherein said user-provided data in said average production goal comprises data received from a group comprising: success ratios; average commission; last predetermined period's average commission percentage; percentage of sides listing sold; percentage of listing-taken sold; percentage of open sides that closed; average days to close; and average days on market.

24. The computer system of claim 21, wherein said step of receiving past personal and business financial data comprises receiving at least a portion of said past personal and business financial data from a pre-calculated average.

25. The method of claim 24, wherein said pre-calculated average comprises an average of user-provided data from a plurality of users, taken from a group consisting of: success ratios; average commission; last predetermined period's average commission percentage; percentage of sides listing sold; percentage of listing—taken sold; percentage of open sides that closed; average days to close; and average days on market.

26. The computer system of claim 21, wherein said past personal and business financial data comprises success ratio, commission, income and expense data from said past period preceding the predetermined forecast period.

27. The computer system of claim 26, wherein said production goal data comprises a commission goal.

28. The computer system of claim 27, wherein said financial forecast data comprises forecasted success ratio, income and expense data necessary to achieve said commission goal.

29. The computer system of claim 28, further comprising transmitting said forecast to the user.

30. The computer system of claim 29, further comprising adjusting said production goal data.

31. The computer system of claim 30, further comprising adjusting any one of said success ratio, income or expense data.

32. The computer system of claim 31, further comprising accepting any one of said success ratio, income or expense data.

33. The computer system of claim 31, further comprising adjusting any one of said success ratio, income or expense data, and accepting any one of said success ratio, income or expense data.

34. The computer system of claim 33, wherein said step of adjusting said production goal data is a function of adjusting data taken from a group consisting of:
(i) listing seasonality; and
(ii) selling seasonality.

35. The computer system of claim 21, wherein said period preceding the predetermined forecast period is at least a one year period.

36. The computer system of claim 21, wherein said past personal and business financial data comprises success ratios, commission, income and expense data from said past period preceding the predetermined forecast period, said production goal data comprises a commission goal, said forecast comprises success ratio, income and expense data, and said method further comprising reporting said forecast data to the user and adjusting said commission goal.

37. The computer system of claim 36, further comprising adjusting any one of said success ratio, income or expense data.

38. The computer system of claim 36, further comprising accepting any one of said success ratio, income or expense data.

39. The computer system of claim 36, further comprising calculating a personal and business financial budget for the predetermined forecast period as a function of said production goal data and said accepted any one of said success ratio, income or expense data.

40. The computer system of claim 39, further comprising generating a monthly worksheet for the predetermined forecast period as a function of said production goal data and said accepted any one of said success ratio, income or expense data.

41. The computer system of claim 21, wherein at least some of the steps are performed over a network between the user and the at least one processing unit.

42. The computer system of claim 41, wherein said network is at least partially coupled to the Internet.

43. A method for providing to a user over a computer network a forecast for a predetermined personal and business financial forecast period, comprising:
providing a website system that includes a graphics user interface having a plurality of data entry fields capable of being populated by the user;
receiving in at least one of said plurality of data entry fields past personal and business financial data from a period preceding the predetermined personal and business financial forecast period;
receiving in at least another one of said data entry fields production goal data for the predetermined forecast period;
calculating a personal and business forecast for the predetermined forecast period as a function of said past personal and business financial data and said production goal data; and
transmitting said forecast to the user via the computer network.

44. The method of claim 43, wherein said step of receiving past personal and business financial data comprises receiving at least a portion of said past personal and business financial data from calculated results of an average production goal of user-provided data.

45. The method of claim 44, wherein said production goal comprises data taken from a group comprising: success ratios; average commission; last predetermined period's average commission percentage; percentage of sides listing sold; percentage of listing-taken sold; percentage of open sides that closed; average days to close; and average days on market.

46. The method of claim 43, wherein said step of receiving past personal and business financial data comprises receiving at least a portion of said financial data from a pre-calculated average.

47. The method of claim 46, wherein said pre-calculated average comprises an average of a plurality of user-provided data taken from a group consisting of: success ratios; average commission; last predetermined period's average commission percentage; percentage of sides listing sold; percentage of listing-taken sold; percentage of open sides that closed; average days to close; and average days on market.

48. The method of claim 43, wherein said past personal and business financial data comprises success ratio, commission, income and expense data from said past period preceding the predetermined forecast period.

49. The method of claim 48, wherein said production goal data comprises a commission goal.

50. The method of claim 49, wherein said forecast data comprises forecasted success ratio, income and expense data necessary to achieve said commission goal.

51. The method of claim 50, further comprising adjusting said production goal data.

52. The computer system of claim 51, wherein said step of adjusting said production goal data is a function of adjusting data taken from a group comprising:
(i) listing seasonality; and
(ii) selling seasonality.

53. The method of claim 43, wherein said period preceding the predetermined forecast period is at least a one year period.

54. The method of claim 43, wherein said past personal and business financial data comprises success ratio, commission, income and expense data from said past period preceding the predetermined forecast period, said production goal data comprising a commission goal, and said financial comprising success ratio, income and expense data, said method further comprising adjusting said commission goal.

55. The method of claim 54, further comprising adjusting any one of said success ratio, income or expense data.

56. The method of claim 54, further comprising accepting any one of said success ratio, income or expense data.

57. The method of claim 54, further comprising adjusting any one of said success ratio, income or expense data, and accepting any one of said success ratio, income or expense data.

58. The method of claim 57, further comprising calculating a personal and business financial budget for the predetermined forecast period as a function of said production goal data and said accepted any one of said success ratio, income or expense data.

59. The method of claim 58, further comprising generating a monthly worksheet for the predetermined forecast period as a function of said production goal data and said accepted any one of said success ratio, income or expense data.

60. A computer implemented method of providing to a user a forecast for a predetermined forecast period, comprising:
receiving past personal and business financial data from a period preceding the predetermined forecast period, said financial data comprising success ratio, commission, income and expense data;
receiving production goal data for the predetermined forecast period, said production goal data comprising a commission goal;
calculating a forecast for the predetermined forecast period as a function of at least said success ratio, commission, income and expense data and at least said commission goal;
transmitting said forecast to the user;
adjusting at least said commission goal;
adjusting at least said success ratio, income or expense data;
accepting at least said commission goal and at least said success ratio, income or expense data;
calculating a financial budget for the predetermined financial forecast period as a function of said accepted commission goal and said accepted success ratio, income and expense data; and
generating a monthly worksheet for the predetermined forecast period as a function of said accepted commission goal and said accepted success ratio, income and expense data.
